(19) United States
(12) Patent Application Publication
(10) Pub. No.: US 2005/0036329 A1
(43) Pub. Date: Feb. 17, 2005

(54) Motor-vehicle headlight

(76) Inventors: Mathias Henschel, Wolfschlugen (DE); Uwe Pfleiderer, Ostelsheim (DE)

Correspondence Address: KENYON & KENYON, ONE BROADWAY, NEW YORK, NY, 10004, US

(21) Appl. No.: 10/888,640

(22) Filed: Jul. 9, 2004

(30) Foreign Application Priority Data
Jul. 11, 2003 (DE) 103 31 349.4

(51) Int. Cl. B60Q 1/26; F21V 7/04

(52) U.S. Cl. 362/496; 362/538; 362/517; 362/511

(57) ABSTRACT

A motor-vehicle headlight, e.g., a front headlight, having a lighting unit, which includes a light source, a reflector surrounding the light source, and a lens device. The reflector essentially reflects the light emitted by the light source, in the direction of the lens device. The headlight includes a housing, which accommodates the lighting unit, and on which a transparent headlight cover is arranged. A light-deflection device or a prepared mounting location for the light-deflection device is provided, which transmits scattered light emitted by the light source to an optical-system part, which is arranged or attachable at essentially any location in the housing.

### CROSS-REFERENCE TO RELATED APPLICATIONS

The present application claims priority to Application No. 103 31 349.4, filed in the Federal Republic of Germany on Jul. 11, 2003, which is expressly incorporated herein in its entirety by reference thereto.

### FIELD OF THE INVENTION

The present invention relates to a motor-vehicle headlight, e.g., a front headlight.

### BACKGROUND INFORMATION

German Published Patent Application No. 197 40 315 describes a headlight unit for motor vehicles, having a light source and a reflector, which reflects the rays of the light source onto a first lens device that spreads out the light in the illuminating direction of the headlight unit. In order to allow, on the whole, as much design flexibility as possible with regard to both a desired signal pattern of the headlight unit and with regard to the outer shape of the headlight unit, means for coupling light, which couple or feed the light beams not cast on the first lens device into a light-guide or fiber-optic guide system having lens apertures or light-outlet areas, are situated about the region between the reflector and the lens device.

In this connection, the lens apertures are positioned in the illumination direction of the vehicle headlight and beams the coupled part of the radiation out of the motor vehicle headlight, in the illumination direction. The main objectives of the light-guide system are to improve the illumination of the region in front of the motor vehicle and therefore strengthen or amplify the signal pattern and accentuate the light pattern or image with regard to the brightness of the motor-vehicle headlight.

Described in Swiss Published Patent Application No. 184 110 is a headlight having a plurality of light sources, e.g., high beam and low beam, and a device, which is for displaying the operation of the light sources and can be influenced by these light sources, and at least one of the light sources being shielded with respect to the display device, in order to indicate, in the display device, whether or not a particular light source is lighting up. In this context, different colored disks, which are illuminated by different light sources, e.g., by the high-beam filament or the low-beam filament, signal to the driver, via the display device, if his or her headlights are emitting a high beam or a low beam, and if the energized incandescent filaments are also really glowing correctly. In this connection, the display device chiefly satisfies safety and verification or monitoring functions.

German Published Patent Application No. 31 42 475 describes an automotive light having a housing and a light bulb, which is seated in a bulb socket and is positioned inside the contour of a reflector, as well as a lens or glass for covering the reflector and the housing, the reflector being made of a hollow piece hermetically sealed by the glass, and an at least partially transparent or translucent indentation extending into the hollow reflector body. The hollow reflector body and the indentation are made of one piece of transparent plastic, the hollow reflector body being coated on the inside with an applied reflective layer. The light bulb is surrounded by an optical system, which deflects light away from the principal beam direction into the direction of optical elements, which are situated in the region of reflector-housing locations, to which no reflective layer is applied and which are therefore transparent. This gives the driver a monitoring option with regard to the luminosity and the functionality of the automotive light.

### SUMMARY

An example embodiment of the present invention may provide a light-deflection device, or a prepared mounting location for the light-deflection device, in a motor-vehicle headlight, which has a light source, a reflector surrounding the light source, and a lens device. The light-deflection device transmits scattered light emitted by the light source to an optical-system part arranged at or attachable at essentially any location in the housing. The reflector essentially beams the light emitted by the light source, in the direction of the lens device, whereas the light-deflection device directs scattered light deviating from the principal beam direction to the described optical-system part and, for example, illuminates it.

This may provide bundling previously unused, scattered light and transmitting it to an arbitrary location in the headlight housing. For example, an optical-system part in the form of a non-luminous object may be positioned there, which means that the design flexibility with regard to the possibility of differentiating between various types of headlight, with regard to brand-specific differentiation, e.g., using an emblem integrated in the optical-system part and illuminated by diffuse incident light, and with regard to an individual night design, is expanded without requiring an additional light source for this. The deflection device may also allow the optical-system part, which is to be illuminated or irradiated, to be positioned behind the reflector in the illuminating direction of the motor-vehicle headlight, and thereby may allow previously unreachable surfaces in the headlight to be utilized.

The light-deflection device may be easily and individually adapted to the specific requirements and inserted into the mounting location provided for it, without producing higher costs or increased expenditure for assembly.

According to an example embodiment, it may be provided that the light-deflection device take the form of a reflector or a light-guide device. Reflectors may be easily and cost-effectively manufactured in nearly any form, e.g., in the form of mirrors or coated elements, and may ensure that light is effectively deflected. In addition, being manufactured in the form of a light-guide device may provide that, in the profile of the light-guide device, branches or bifurcations may be provided which transmit the coupled light in different directions, e.g., to a plurality of optical-system parts, and thereby may additionally increase the design flexibility.

In general, it may also be possible to design the light-deflection device as a prism, which may provide the optical feature of emitting light differentiated with respect to color on the side from which light emerges. This may allow a color-differentiated night design to be generated, which may produce an unmistakable, nighttime signal pattern, and therefore, the design may be easily associated with a particular headlight or vehicle type and may make it easier for one to recognize it.

According to an example embodiment, the optical-system part may have optical-system elements, which are designed to refract and/or deflect the light. In this context, the optical-system elements may, for example, take the form of light guides, prisms, etc. and may individually illuminate the non-luminous object.

Furthermore, an example embodiment of the present invention may provide for the optical-system part to have an emblem, which is illuminated by the diffuse incident light. For example, handwriting, logos, etc., which make it easier to associate the product with a particular brand and/or company, e.g., in a nighttime setting, may be considered as emblems. It may be possible to identify different types within a series or model line by variably positioning, shaping and/or arranging the emblems.

The optical-system part may be made of heat-resistant and transparent plastic, e.g., acrylic glass. Optical-system parts made of acrylic glass may provide that they may be manufactured as injection-molded parts in almost any shape and may easily be adapted to specific requirements. In addition, they may have a low density, and therefore, they may only effect the overall weight of the vehicle marginally. In addition, the consequences of an injury in a possible accident may be assessed as considerably better in the case of acrylic glass than in the case of glass optical-system parts.

According to an example embodiment of the present invention, a motor-vehicle headlight includes: a lighting unit including a light source, a reflector surrounding the light source and a lens, the reflector arranged to focus light emitted by the light source in a direction of the lens; a housing arranged to accommodate the lighting unit; a transparent headlight cover arranged on the housing; and one of (a) a light-deflection device and (b) a prepared mounting location for the light-deflection device arranged to transmit scattered light emitted by the light source to an optical-system part one of (a) arranged and (b) attachable at substantially any location in the housing.

The light-deflection device may be arranged between the lens and one of (a) the reflector and (b) a main part of the reflector at a radial distance from an optical axis of the lighting unit.

The light-deflection device may be arranged as a reflector.

The light-deflection device may be arranged as a light-guide device.

The optical-system part may be arranged behind the reflector in an illumination direction of the motor-vehicle headlight.

The optical-system part may include a diffusely reflective surface.

The optical-system part may be arranged as a part of one of (a) the lighting unit and (b) the housing.

The optical-system part may be arranged as a part of one of (a) a cover frame and (b) a reflector surface.

The optical-system part may include optical elements configured to at least one of (a) refract and (b) deflect the light.

The optical-system part may include at least one emblem arranged to be illuminated by diffuse incident light.

The optical-system part may be made of heat-resistant and transparent plastic.

The optical-system part may be made of acrylic glass.

The optical-system part may be arranged to produce a clearly defined night design.

The motor-vehicle headlight may correspond to a front headlight.

According to an example embodiment of the present invention, a motor-vehicle headlight includes: lighting means including light source means, reflector means surrounding the light source means and lens means, the reflector means for focusing light emitted by the light source means in a direction of the lens means; housing means for accommodating the lighting means; transparent headlight cover means arranged on the housing means; and one of (a) a light-deflection means and (b) a prepared mounting means for the light-deflection device means for transmitting scattered light emitted by the light source means to an optical-system means one of (a) arranged and (b) attachable at substantially any location in the housing means. Additional features and aspects of example embodiments of the present invention are described below with reference to the appended Figures.

The features indicated above in the following are usable not only in each specified combination, but also in other combinations or by themselves.

An exemplary embodiment of the present invention is illustrated in the Figure and explained in detail in the following description.

### BRIEF DESCRIPTION OF THE DRAWING

FIG. 1 is a longitudinal cross-sectional view of a motor-vehicle headlight according to an example embodiment of the present invention.

### DETAILED DESCRIPTION

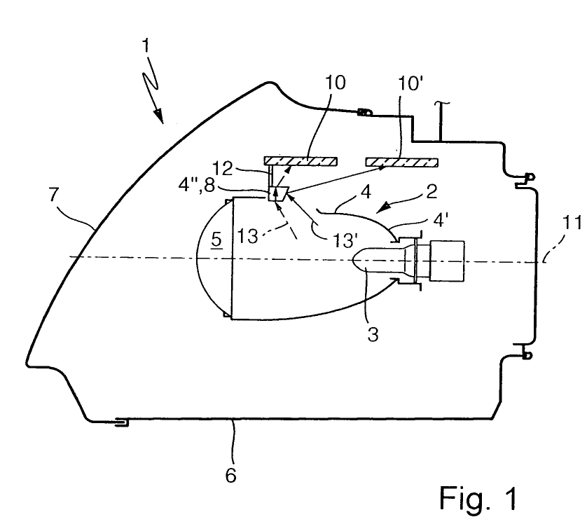

As illustrated in FIG. 1, a motor-vehicle headlight 1 according to an example embodiment of the present invention has a lighting unit 2, which includes a light source 3, a reflector 4 surrounding the light source, and a lens device 5. Reflector 4 essentially reflects the light emitted by light source 3 as a parallel bundle of light in the direction of lens device 5. Lighting unit 2 is arranged in a housing 6, which is terminated in the illumination direction of motor-vehicle headlight 1 by a transparent headlight cover 7. Reflector 4 may be designed to be essentially closed up to lens device 5, or to have an opening, which constitutes a prepared mounting position for a light-deflection device 8, and into which light-deflection device may be inserted.

Light-deflection device 8 transmits scattered light 13, 13′ emitted by light source 3 to an optical-system part 10 and 10′, respectively, which is arranged or attachable at essentially any location in housing 6. In this context, light-deflection device 8 is positioned between reflector 4 or main part 4′ of the reflector and lens device 5, at a radial distance from optical axis 11 of lighting unit 2.

In this context, light-deflection device 8 may take the form of a reflector 4″ or a light-guide device 12. In the case of a reflector 4″, scattered incident light 13 is reflected and transmitted to optical-system part 10′.

For example, an optical path for scattered light 13 (broken line) is also illustrated, which ensues for the case in which light-deflection device 8 takes the form of a prism. In this case, scattered light 13 is refracted in light-deflection device 8 and, e.g., transmitted to optical-system part 10. In addition, it is possible to split up scattered light 13 by color, so that light differentiated by color is emitted on the side from which light emerges. Consequently, a night design differentiated by color may be produced, which may easily be associated with a particular type of headlight or vehicle and may increase the recognition effect.

An example embodiment, in which light-deflection device 8 takes the form of light-guide device 12 and is connected to a corresponding optical-system part, in this case optical-system part 10, is also illustrated in FIG. 1. However, it is also possible that light-guide device 12 branches and has several optical fibers, which are connected to a plurality of optical-system parts 10, 10′.

As illustrated in FIG. 1, optical-system part 10 or 10′ may be arranged or attached at essentially any location in housing 6, e.g., in the illumination direction of motor-vehicle headlight 1, as well, in back of reflector 4 or in back of lighting unit 2. This may allow a particularly high level of design freedom and the utilization of previously unused space inside housing 6.

Optical-system part 10, 10′ may have both a diffusely reflective surface and an emblem, which is integrated into optical-system part 10, 10′ and illuminated by scattered incident light 13, 13′. In this connection, logos, handwriting, advertising symbols, etc. may be considered as emblems, with the aid of which, in the event of darkness, headlight 1 generates a clearly defined night design and/or a particular vehicle make or vehicle series is already assignable or recognizable at some distance, due to the illuminated emblem.

It is also possible for optical-system part 10, 10′ to have additional optical elements, which are designed to refract and/or deflect the light. For example, in the case of an optical-system part 10, 10′ made of heat-resistant and transparent plastic, e.g., acrylic glass, such optical elements may easily be produced in the form of notches, layers, mounted prisms, etc.

In a motor-vehicle headlight 1, which has a light source 3, a reflector 4, and a lens device 5, an example embodiment of the present invention may provide a light-deflection device 8 or a prepared mounting location 9 for light-deflection device 8, which transmits scattered light 13, 13′ emitted by light source 3 to an optical-system part 10, which is arranged or attachable at essentially any location in housing 6.

This may expand the design flexibility with regard to an individual or original night design, without requiring an additional light source 3 for this.

In addition, deflection device 8 also allows optical-system part 10, 10′ to be arranged in back of reflector 4, in the illumination direction of motor-vehicle headlight 1.

Light-deflection device 8 may take the form of a reflector 4″, a light-guide device 12, a prism, etc.

1. A motor-vehicle headlight, comprising:
a lighting unit including a light source, a reflector surrounding the light source and a lens, the reflector arranged to focus light emitted by the light source in a direction of the lens;
a housing arranged to accommodate the lighting unit;
a transparent headlight cover arranged on the housing; and
one of (a) a light-deflection device and (b) a prepared mounting location for the light-deflection device arranged to transmit scattered light emitted by the light source to an optical-system part one of (a) arranged and (b) attachable at substantially any location in the housing.

2. The motor-vehicle headlight according to claim 1, wherein the light-deflection device is arranged between the lens and one of (a) the reflector and (b) a main part of the reflector at a radial distance from an optical axis of the lighting unit.

3. The motor-vehicle headlight according to claim 1, wherein the light-deflection device is arranged as a reflector.

4. The motor-vehicle headlight according to claim 1, wherein the light-deflection device is arranged as a light-guide device.

5. The motor-vehicle headlight according to claim 1, wherein the optical-system part is arranged behind the reflector in an illumination direction of the motor-vehicle headlight.

6. The motor-vehicle headlight according to claim 1, wherein the optical-system part includes a diffusely reflective surface.

7. The motor-vehicle headlight according to claim 1, wherein the optical-system part is arranged as a part of one of (a) the lighting unit and (b) the housing.

8. The motor-vehicle headlight according to claim 7, wherein the optical-system part is arranged as a part of one of (a) a cover frame and (b) a reflector surface.

9. The motor-vehicle headlight according to claim 1, wherein the optical-system part includes optical elements configured to at least one of (a) refract and (b) deflect the light.

10. The motor-vehicle headlight according to claim 1, wherein the optical-system part includes at least one emblem arranged to be illuminated by diffuse incident light.

11. The motor-vehicle headlight according to claim 1, wherein the optical-system part is made of heat-resistant and transparent plastic.

12. The motor-vehicle headlight according to claim 1, wherein the optical-system part is made of acrylic glass.

13. The motor-vehicle headlight according to claim 1, wherein the optical-system part is arranged to produce a clearly defined night design.

14. The motor-vehicle headlight according to claim 1, wherein the motor-vehicle headlight corresponds to a front headlight.

15. A motor-vehicle headlight, comprising:
lighting means including light source means, reflector means surrounding the light source means and lens means, the reflector means for focusing light emitted by the light source means in a direction of the lens means;
housing means for accommodating the lighting means;
transparent headlight cover means arranged on the housing means; and
one of (a) a light-deflection means and (b) a prepared mounting means for the light-deflection device means for transmitting scattered light emitted by the light source means to an optical-system means one of (a) arranged and (b) attachable at substantially any location in the housing means.

16. The motor-vehicle headlight according to claim 1, wherein the light-deflection device is arranged between one of (a) the lens and (b) the transparent headlight cover and one of (a) the reflector and (b) a main part of the reflector at a radial distance from an optical axis of the lighting unit.
